(19) United States
(12) Patent Application Publication
(10) Pub. No.: US 2010/0304676 A1
(43) Pub. Date: Dec. 2, 2010

(54) BLUETOOTH HEADSET

(75) Inventor: Ju Won HEO, DaeGu-City (KR)

Correspondence Address: LOWE HAUPTMAN HAM & BERNER, LLP, 1700 DIAGONAL ROAD, SUITE 300, ALEXANDRIA, VA, 22314, US

(73) Assignee: GT Telecom Co., Ltd., Gumi-Shi (KR)

(21) Appl. No.: 12/472,733

(22) Filed: May 27, 2009

(51) Int. Cl. H04B 7/00

(52) U.S. Cl. 455/41.3

(57) ABSTRACT

Disclosed is a Bluetooth headset including: a headset body, which is a casing having an earphone part; a function button embedded in a rear or lateral side of the headset body, which is used to operate a function of the Bluetooth headset, wherein in a storage space of the headset body, a circuit board is placed, the circuit board being designed for mounting an operating switch (such as an electric button switch) that operates by cooperation with the function button; and a position changing means for changing a position of the function button with respect to the operating switch according to an operation of the function button by a user, wherein the function button and the operating switch are aligned with or misaligned from each other by the position changing means, so that a pressing of the function button provides an operable unlocked state or a non-operable locked state where operation or non-operation of the operating switch is selectively carried out.

### BACKGROUND OF THE INVENTION

1. Field of the Invention

The present invention relates to a Bluetooth headset, and more particularly to a mechanical configuration for setting an operating mode of the Bluetooth headset, which can provide an additional operation mode by means of an electrical circuit cooperating with the mechanical configuration, thereby solving the problems of the conventional configuration and enhancing the convenience of users.

2. Description of the Prior Art

A sound source device employing a “Bluetooth” protocol which is one of wireless transmission systems and a low power local area wireless transmission protocol, and a Bluetooth headset reproducing the sound source wirelessly transmitted from the sound source device, have recently been popularized to be applied to sound source generating devices, such as portable communication devices, notebooks, MP3 players.

A headset using such a Bluetooth protocol can transmit transmitting/receiving sounds with low power, which makes it possible to communicate freely from an additional wire or cable and requires very low power consumption, and thus based on the usefulness of very low power consumption, various applications and products for implementing the applications are being produced.

### SUMMARY OF THE INVENTION

One of the most important advantages of a Bluetooth headset employing Bluetooth is easiness of carrying, and in order to secure such portability and to simply configure a user interface, the number of outer controlling buttons or switches is minimized.

In general, each Bluetooth headset independently has a single control button (a function button). In the case of a cellular phone, the Bluetooth headset is configured in such a manner that operations, such as call starting, call ending, re-dialing, are carried out according to the control mode and the number of times the function button is operated.

An operating method of such a function button is set variously according to production companies.

For example, according to the type of cellular phones, (a) when a function button is pressed, the last dialed number is set, and then when the function button is pressed again after the setting, dialing is performed, or (b) when a function button is pressed, the last dialed number is immediately redialed. In other words, it is possible to set various operation modes.

When a Bluetooth headset, whose control methods are set as described above, is placed in a pocket or a bag carried by a user, unintentional call starting or re-dialing may be performed by pressing from the outside, which causes a problem, such as a waste of communication expense, inconveniencing the recipient who receives the useless calls.

One example of the conventional technical configuration is shown in FIG. 1.

As shown, a conventional Bluetooth headset S includes one or more function buttons F for controlling a headset body B. Meanwhile, a sound controlling key (not shown) is generally additionally mounted on the lateral side of the headset body B.

In the example, where there exists only one function button F, one short pressing (a), two short pressings (b), and a long pressing (c) of a push-button type function button F initiates call starting, call ending, and redialing, respectively.

In a Bluetooth headset S having such a conventional configuration, the function button F is generally disposed at the rear side of the earphone part E to be inserted in the ear of a user by taking into consideration the user's convenience. Thus, when an external force is added within a pocket or a bag, the above mentioned unintentional operation of the function button F is easily caused, thereby causing the above described problem.

Accordingly, the present invention has been made to solve the above-mentioned problems occurring in the conventional Bluetooth headset. The present invention provides a mechanical configuration for preventing a function button from being unintentionally operated by a user, and an electrical configuration cooperating with the mechanical configuration.

From the technical/economical standpoint, another important advantage of the Bluetooth headset is an increase in the available stand-by time of the built-in battery. The increase of the available stand-by time of the Bluetooth headset, together with the performance of the Bluetooth headset, has aroused customer's interest, because unlike the recharging of a main body of a cellular phone, etc., the recharging of the Bluetooth headset may often be neglected with inattention, thereby causing the device to power off during the carrying of the device.

As the available stand-by time of a battery increases, the necessity of recharging decreases. Thus, it is possible to maximize user's convenience and to minimize user's loss caused by the impossibility of making a call at crucial times. Therefore, many Bluetooth headset producing companies have made an attempt to increase the usable life of a battery, especially the available stand-by time.

In order to increase the battery's available stand-by life, the headset is preferably configured to reduce loss caused by the time consumed by a user's unintentional control mistake and to basically mechanically prevent the user's control mistake as well as to improve the battery's own performance.

Furthermore, the control method of an electrical power-saving function cooperating with such a mechanical control is also important from the technical standpoint.

Therefore, the present invention has been made to overcome the above-mentioned problems and it is an object of the present invention to provide a mechanical configuration of a Bluetooth headset, which can prevent a user's unintentional switch control mistake, and a power controlling means cooperating with the mechanical configuration, which can remarkably increase the available stand-by time of the battery of the Bluetooth headset.

In accordance with an aspect of the present invention, there is provided a Bluetooth headset including: a headset body, which is a casing having an earphone part; a function button embedded in a rear or lateral side of the headset body, which is used to operate a function of the Bluetooth headset, wherein in a storage space of the headset body, a circuit board is placed, the circuit board being designed for mounting an operating switch (such as an electric button switch) that operates by cooperation with the function button; and a position changing means for changing a position of the function button with respect to the operating switch according to an operation of the function button by a user, wherein the function button and the operating switch are aligned with or misaligned from each other by the position changing means, so that a pressing of the function button provides an operable unlocked state or a non-operable locked state where operation or non-operation of the operating switch is selectively carried out.

In accordance with another aspect of the present invention, there is provided a Bluetooth headset including: a headset body, which is a casing having an earphone part; a function button embedded in a rear or lateral side of the headset body, which is used to operate a function of the Bluetooth headset, wherein in a storage space of the headset body, a circuit board is placed, the circuit board being designed for mounting an operating switch (such as an electric button switch) that operates by cooperation with the function button; and a position changing means for changing a position of the function button with respect to the operating switch according to an operation of the function button by a user, wherein the function button and the operating switch are aligned with or misaligned from each other by the position changing means, so that a pressing of the function button provides an operable unlocked state or a non-operable locked state where operation or non-operation of the operating switch is selectively carried out, wherein, in addition to a selecting function of the non-operable locked state or operable unlocked state, a power saving means for converting power of the Bluetooth headset into an OFF mode or a sleep mode is further provided.

First, the Bluetooth headset according to the present invention can basically prevent a user's unintentional operation through a mechanical configuration. Thus, it is possible to solve problems, such as a waste of communication expense, inconvenience of the recipient who receives useless calls, caused by unintentional call starting or re-dialing.

Second, from a main technical standpoint, the Bluetooth headset can greatly increase a stand-by time of a battery by providing a stand-by function of a power-saving function by an electrical configuration cooperating with the mechanical configuration of the Bluetooth headset.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a conventional exemplary Bluetooth headset;

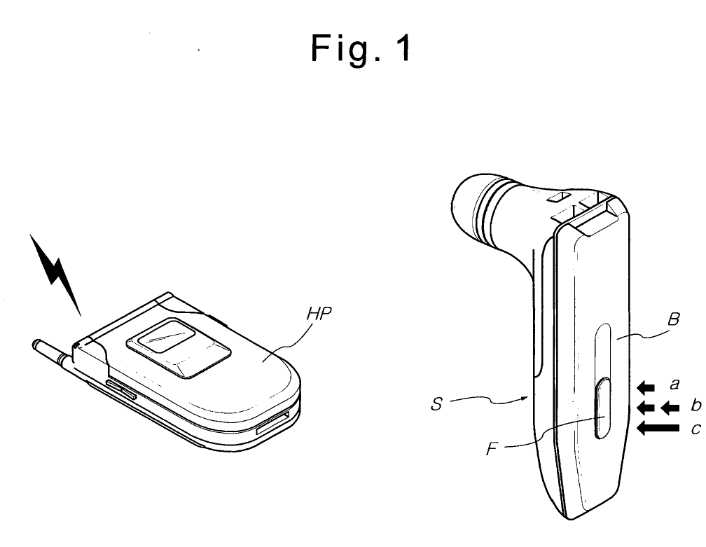

FIG. 2a is a sectional side view illustrating a locking mode of a Bluetooth headset according to a first embodiment of the present invention;

FIG. 2b is a plan view of FIG. 2a;

FIG. 2c is a plan view in which the function button is removed from the Bluetooth headset as shown in FIG. 2b.

FIG. 3a is a sectional side view illustrating an unlocking mode of a Bluetooth headset according to a first embodiment of the present invention;

FIG. 3b is a plan view of FIG. 3a;

FIG. 4a is a sectional side view illustrating a locking mode of a Bluetooth headset according to a second embodiment of the present invention;

FIG. 4b shows a plan view of FIG. 4a, and a sectional view taken along the direction indicated by a line A-A;

FIG. 5a is a sectional side view illustrating an unlocking mode of a Bluetooth headset according to a second embodiment of the present invention;

FIG. 5b is a plan view of FIG. 5a;

FIG. 6a is a sectional side view illustrating an unlocking mode of a Bluetooth headset according to a third embodiment of the present invention;

FIG. 6b is a plan view of FIG. 6a;

FIG. 7a is a sectional side view illustrating an unlocking mode of a Bluetooth headset according to a fourth embodiment of the present invention;

FIG. 7b is a plan view of FIG. 7a;

FIG. 7c is a sectional side view illustrating a locking mode of a Bluetooth headset according to a fourth embodiment of the present invention;

FIG. 7d is a plan view of FIG. 7c;

FIG. 8 is a perspective view illustrating a locking mode of a Bluetooth headset according to a fourth embodiment of the present invention; and

FIG. 9 is a perspective view illustrating a Bluetooth headset according to a fifth embodiment of the present invention, which is a modified fourth embodiment.

### DETAILED DESCRIPTION OF THE EXEMPLARY EMBODIMENTS

Hereinafter, the configuration and operation of a Bluetooth headset according to the present invention will be described with reference to the accompanying drawings.

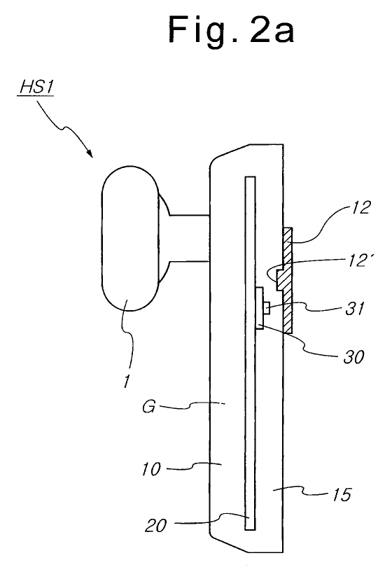

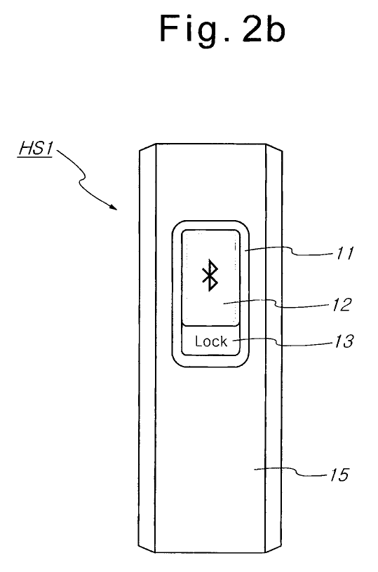

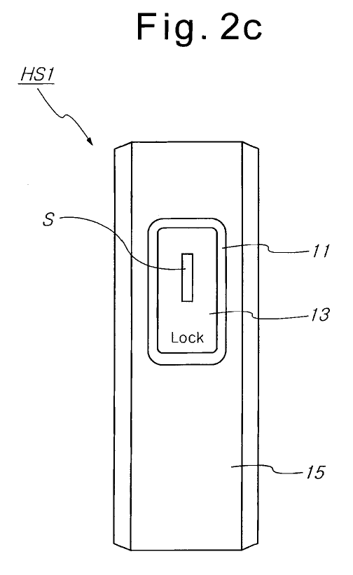

The Bluetooth headset (HS) according to the present invention, which has been designed by taking into consideration the problem of the conventional Bluetooth headset, will be described with reference to embodiments as shown in FIGS. 2 to 9.

### First Embodiment

The technical spirit of a Bluetooth headset HS1 according to a first embodiment of the present invention is to provide a mechanical configuration, which allows selective operation or non-operation of a function button performing various functions. Herein, the operation/non-operation is carried out by mechanically aligning the function button (which is a push button) with an operating switch interworking with the function button (an in-line state), or by releasing the in-line state.

Referring to FIG. 2 which shows a cross-sectional view of the Bluetooth headset HS1 having an exemplary design and configuration, according to a first embodiment of the present invention, the Bluetooth headset HS1 has a headset body 10 having an earphone part 1, and a slide-switch type function button 12 provided at the rear or lateral side of the headset body 10.

In a storage space G formed by the headset body 10, a circuit board 20 seating a micom (not shown) (that is, a chip for the control of the Bluetooth headset) is placed.

In the Bluetooth headset HS1 according to the present invention, the slide-switch/push-button type function button 12 is provided to the headset body 10.

Also, the operation of the Bluetooth headset depends on the mechanical position setting, that is, whether or not a button part 31 of a button switch 30 (that is, a conventional push button) mounted on the circuit board 20 corresponds to the position of the function button 12 or a guide projection 12′ that is integrally formed on the undersurface of the function button 12 and functions as an upward/downward guide.

In the first embodiment as a preferred embodiment provided to achieve such a purpose, in order to realize the operational configuration of the function button 12 for the button part 31 of the button switch 30, a button area 13 that is separated from a button body 15 as the rear side surface of the headset body 10 is formed. Also, between the button area 13 and the button body 15, an elastic ring 11 is provided through coupling, thereby facilitating the pressing operation.

The elastic ring 11 is formed by intervening a ring body made from an elastic material (such as rubber), between the button area 13 and the button body 15 so as to facilitate the pressing operation of the function button 12, or is formed by carrying out a pressing process of a metal board integrally including the button body 15 and the function button 12, and by using a curved sectional spring member for providing elasticity, which facilitates repetitive pressing operations of the function button 12 by a user.

Of course, in the case where the button body 15 is formed by an elastic sheet-type metal board or mold, there is no need to employ the elastic ring 11 because the upward/downward displacement is possible to some extent due to the material's own elasticity.

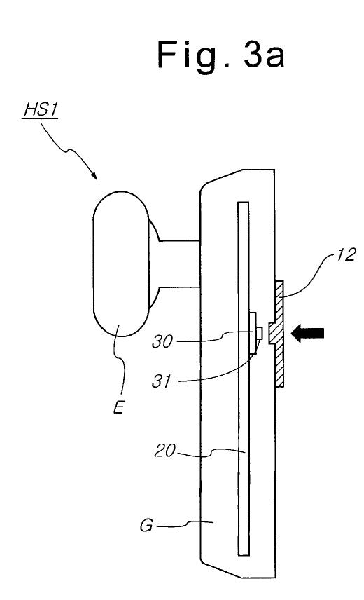

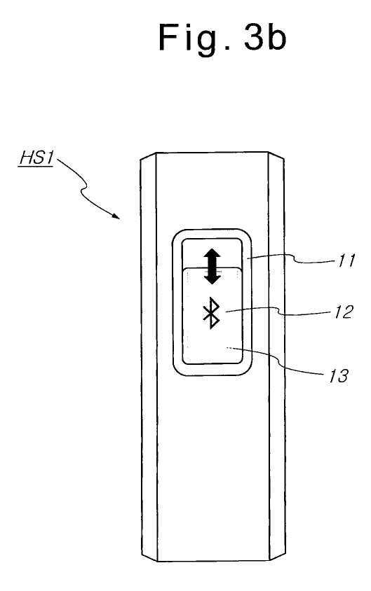

Also, it is preferable that like a slide switch as shown in FIG. 3b, the function button 12 is put into the button area 13 through a slot S (see FIG. 2c) in such a manner that it can slide upward/downward or left and right, which allows upward/downward sliding movements as shown in the drawings as well as pressing operations toward the ground.

Also, it is preferable that the function button 12 has, beneath the function button 12, a protruding guide projection 12′ which corresponds to the button part 31 of the button switch 30 in the in-line state between them.

The function button 12 or the guide projection 12′ of the function button 12, and the button part 31 of the button switch 30 can be in an in-line position (FIG. 3a) or a non-in-line position (FIG. 2a) by the upward/downward sliding movement of the function button 12. Thus, at the start of the use of the Bluetooth headset HS1, when the user moves the function button 12 from the non-in-line position to the in-line position (as shown in FIG. 3) by sliding the function button 12, the function button 12 can be subjected to pressing operations due to the existence of the elastic ring 11.

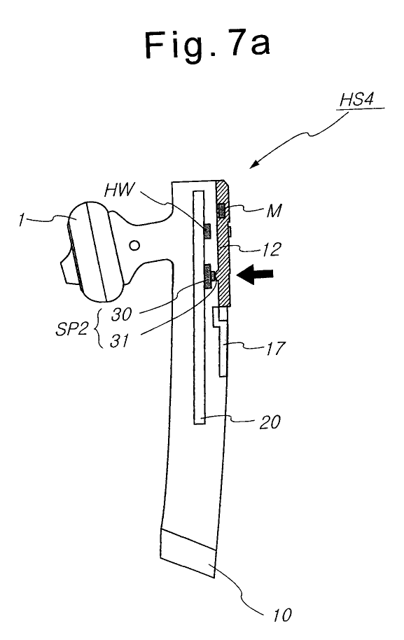

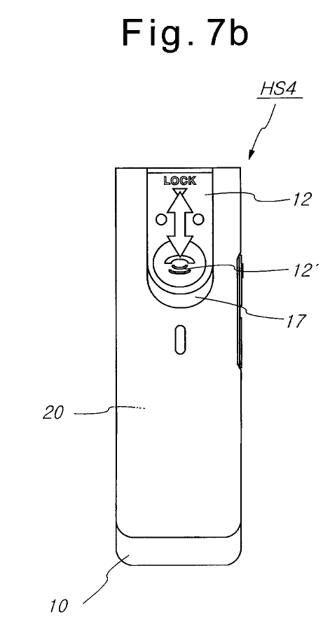

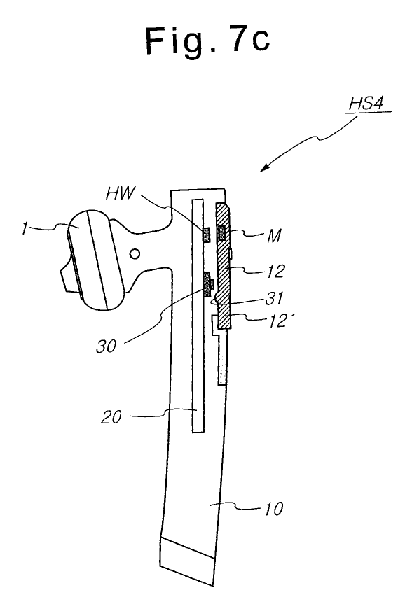

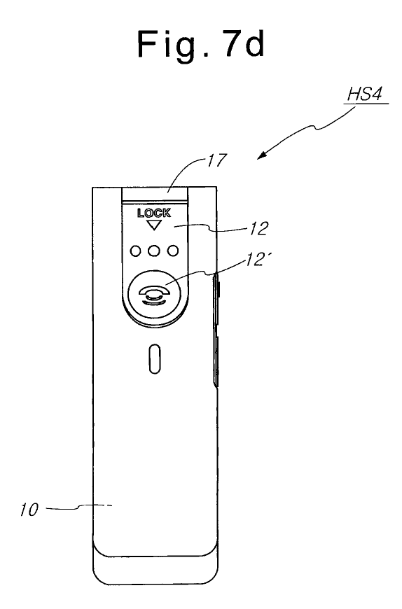

Otherwise, it is possible to configure the function button 12 without the guide projection 12′, which employs a knob guide 17 and is described in a fifth embodiment as shown in FIG. 7a. In this configuration, the function button 12, according to its upward/downward sliding movement, can perform a pressing operation in an unlocked position, and can prevent the button switch 30 from operating by not being mechanically pressed in a locked position, which can be variably applicable according to mechanical designs.

Accordingly, in the case where the Bluetooth headset HS1 is put in a bag or a pocket by a user, when the switch and button are in a non-in-line position and in a non-operable locked state as shown in FIGS. 2a and 2b, the button part 31 of the button switch 30 is not pressed by an unintentional pressing operation of the function button 12 from the outside.

### Second Embodiment

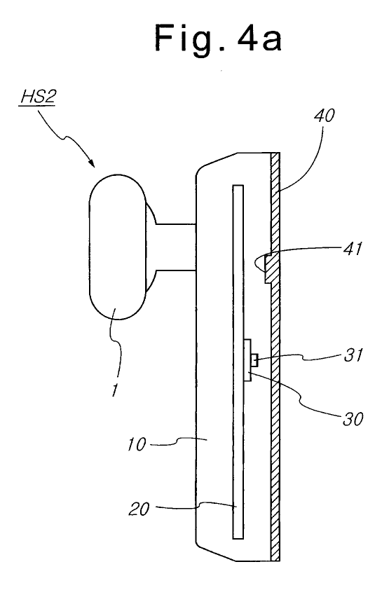

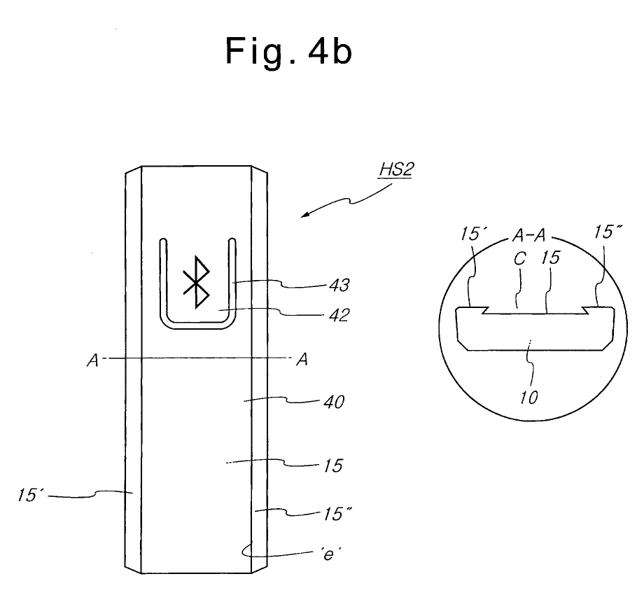

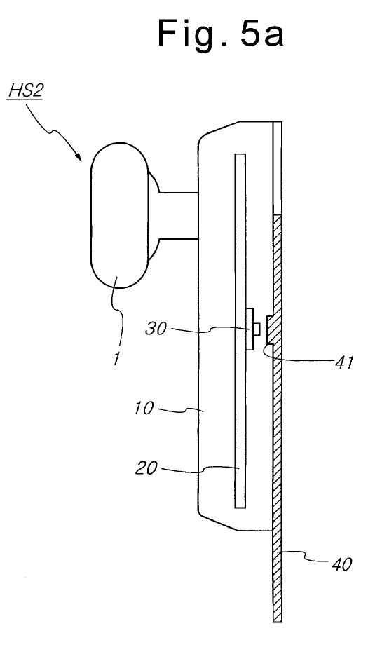

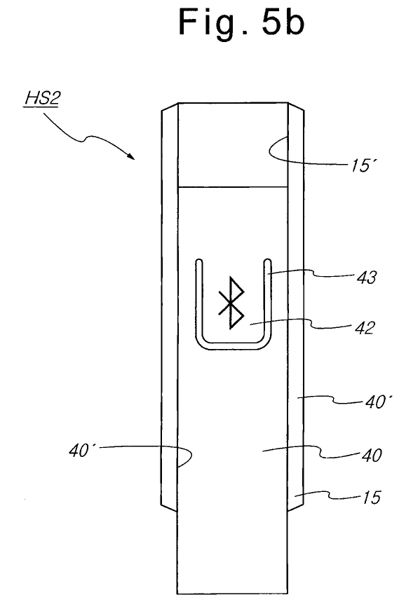

In the switching configuration according to the first embodiment in the in-line/non-in-line state of the button part 31 of the button switch 30 with the function button 12, the mechanical design of switch operating parts can be changeable. The Bluetooth headset HS2 according to an exemplary preferred second embodiment is shown in FIGS. 4 and 5.

The present embodiment is characterized in that it is configured by modifying sliding operation elements of the first embodiment.

The Bluetooth headset HS2 has a headset body 10 having an earphone part 1, and a button body 15 as the rear or lateral surface (shown as the rear surface in drawings) of the headset body 10. At the button body 15, a couple of channel guides 15′ and 15″ are grooved into the headset body, which extend in upward/downward directions and are separated from each other.

An upwardly/downwardly slidable cover plate 40 is put between the channel guides 15′ and 15″.

Accordingly, it is preferable that the inside of the channel guides 15′ and 15″ is inwardly inclined, thereby preventing the derailment of the cover plate 40. Such inward inclination is shown in a sectional view taken along the direction indicated by a line A-A in FIG. 4b.

Also, on the cover plate 40, as a movable member capable of pressing a button part 31 of a button switch 30 on a circuit board 20 in an operable position (that is, an unlocked position as shown in FIG. 5a) where the cover plate 40 is moved downward, an elastic press part 42 is provided.

The elastic press part 42 provided on the cover plate 40 of the Bluetooth headset HS2, as shown, may be formed by a plate-shape member made from a metal material by cutting the cover plate 40 into a ‘U’-shape while leaving one side of the elastic press part 42 uncut so that it can perform the same role as the function button 12 by functioning as a switch by its own elasticity.

Also, in the above described configuration, in the same manner as the first embodiment, the conversion from the non-operation mode as shown in FIG. 4a into the operation mode (that is, an unlocked mode) as shown in FIG. 5a by the user can prevent unintentional pressing operations on the elastic press part 42.

### Third Embodiment

In addition to the above described functions according to the first and second embodiments, where the user's unintentional operational mistakes can be prevented through the setting of the operation/non-operation modes, the Bluetooth headset of the present invention can have an additional function for entering the headset into a power-saving mode at a stand-by state, which can result in a great increase in stand-by power.

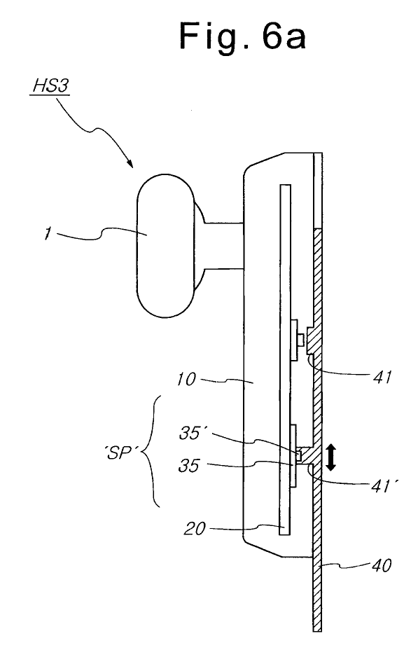

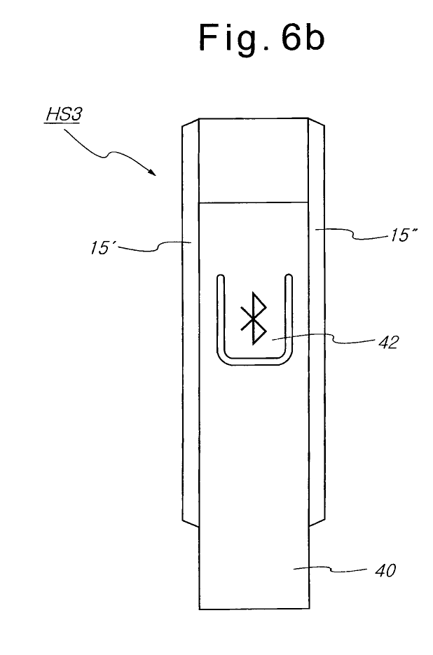

The Bluetooth headset HS3 according to a third embodiment, which further includes such a power-saving function, is shown as different embodiments in FIGS. 6, 7 and 8.

The configuration of the Bluetooth headset HS3 according to the present embodiment may be added to the Bluetooth headset HS1 according to the first embodiment, in which operation/non-operation depends on the in-line/non-in-line state of the slide-switch type function button 12 with the button part 31 of the button switch 30 on the circuit board 20, or may be added to the Bluetooth headset HS3 according to the third embodiment as a modified embodiment of the second embodiment, in which the cover plate 40 is put between the channel guides 15′ and 15″ and can press down the button part 31 by upward/downward sliding movements, and the operation/non-operation depends on the in-line/non-in-line state of the function button 42 with the button part 31 of the button switch 30 on the circuit board 20.

However, as shown in FIGS. 6a and 6b, the Bluetooth headset BS3 according to the present third embodiment includes, besides the elements of the second embodiment, another knob projection 41′ protruding from the lower portion of a cover plate 40; and a power saving switch SP, which is configured by coupling a knob 35′ of another slide switch 35 additionally mounted on the circuit board 20 with the knob projection 41′.

In this configuration, when the cover plate 40 is in a non-operating state at the upper position, ON/OFF of the signal, which is caused by the operation of the power saving switch SP for the operation of the function button 12, is sensed by a controlling micom mounted on the circuit board 20. Then, a certain port of the micom converts the ON/OFF state of the power saving switch SP into a ‘HIGH’ or ‘LOW’ state prior to the input of the signal. For this, a controlling program is installed in the micom (which is a built-in chip of the Bluetooth headset). The controlling program is used for activating the operation of the function button 12 at a HIGH state by converting it into an operation mode (a stand-by state of Bluetooth), entering the Bluetooth into a sleep mode (that is, a power-saving mode) at a LOW state by disconnecting the Bluetooth from the main body, or performing a kind of power saving mode, that is, a Power-OFF mode, to reduce the consumption of current.

In other words, when the relevant port of the micom is converted from ‘LOW’ to ‘HIGH’ by the ON/OFF of the power saving switch SP, the micom can release the sleep mode, and otherwise, at the Power-Off mode, the micom connects the Bluetooth with the main body by Power-On, thereby returning the operation of the function button 12 to a stand-by state. This can achieve a power-saving function, resulting in a great increase in stand-by time.

### Fourth Embodiment

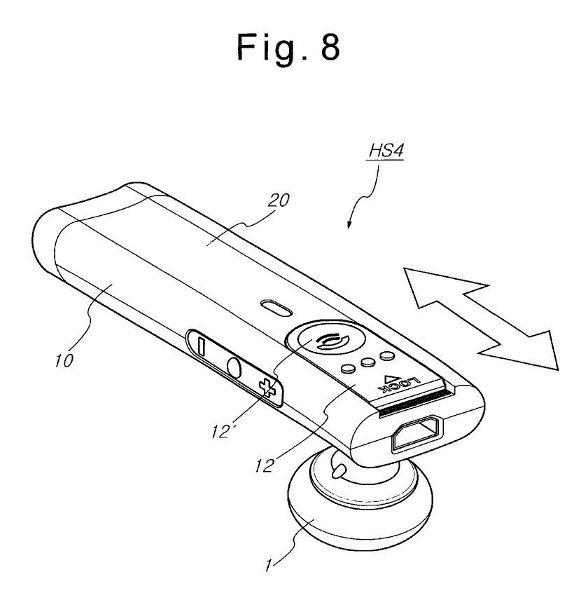

As shown in FIGS. 7 and 8, a Bluetooth headset HS4 according to a fourth embodiment includes a power saving switch SP as a contactless electrical switch device, unlike the third embodiment in which the power saving switch SP has a mechanical configuration.

The Bluetooth headset according to the present invention may further include, as the contactless electrical switch device, a power saving switch SP2 using a magnet-sensitive hall switch that electrically switches ON/OFF in response to an adjacent magnet.

The Bluetooth headset HS4 according to the present invention includes a knob guide 17, in addition to the elements of the Bluetooth headset HS1 according to the first embodiment in which in the mechanical configuration allowing the function button 12 performing conventional functions to be selectively operated or non-operated, operation/non-operation depends on the in-line/non-in-line state of the slide switch type function button 12 with the operating switch, that is, the button part 31, on the circuit board 20. The knob guide 17 restricts the sliding movement of a function button 12 within a certain range. Herein, the function button 12 cooperates with a button switch 30 on a circuit board 20 in such a manner that it can perform the same operation as the first embodiment.

For the power saving switching configuration SP2 for providing a power saving function, in the upper portion of the function button 12, a magnet M is embedded, and on the circuit board 20, a hall switch HS sensitive to the magnet M is provided.

It is preferable that in an operable unlocked position as shown in FIG. 7a, the magnet M is separated from the hall switch HW, and in a non-operable locked position as shown in FIG. 7c, the magnet M is adjacent to the hall switch HW. However, of course, the above mentioned configuration may be inversely carried out according to the built-in program of a micom.

The magnet M and the hall switch HW operate as a power saving switch SP2, aside from the operation/non-operation modes in the conventional function of the function button 12.

As shown in FIG. 7a, in the unlocked state (that is, an operable stand-by state) caused by the upward/downward movement of the function button 12, the magnet M embedded in the function button 12 is misaligned with the hall switch HW provided on the circuit board 20.

Herein, since the hall switch HW is not operated by the magnet M, the output of the hall switch is ‘HIGH’. Then, the built-in-type Bluetooth-headset controlling micom of the circuit board 20 recognizes the ‘HIGH’ state, and maintains a normal operation state, that is, a stand-by state of the function button 12, which allows the Bluetooth headset to perform normal operations, such as call receiving/sending functions. In such a normal mode, when the user presses down on the function button 12, the button switch 30 is pressed, thereby performing functions.

As shown in FIG. 7c, in the locked state caused by the downward movement of the function button 12, since the hall switch HW is operated by the magnet M, the output of the hall switch is changed from ‘HIGH’ to ‘LOW’. Then, a power-saving mode for minimizing current consumption is performed, in which the micom recognizes the ‘LOW’ state, transmits a disconnection data to a Bluetooth-using main body, such as a cellular phone or an MP3 player, disconnects from the main body having the Bluetooth mounted thereto, and turns the power off.

Unlike the above described power-saving mode for entering the Bluetooth headset into a power OFF mode by the hall switch HW sensitive to the magnet M, another control method employs a programmatic control, in which in a power saving mode, the Bluetooth headset is entered into a sleep mode (a low current stand-by state) through the disconnection from the main body.

In the power saving mode, that is, a sleep mode or a power-off mode, when the button switch 30 is pressed by the user's unintentional pressing operation on the function button 12, the micom does not recognize this. Thus, the hall switch functions as a power saving switch SP2 which can prevent call sending by the button pressing operation caused by mistake, and thereby increasing the battery stand-by time of the Bluetooth headset HS4 according to the present invention by at least 10 fold.

In a further modified preferred configuration, an automatic call receiving function is provided, in addition to the above described routine in which the function button 12 is moved from a locked state to an unlocked state, the output of the hall switch is changed from ‘LOW’ to ‘HIGH’, and then the micom recognizing this turns the power of the Bluetooth headset H3 on and performs a connection with the main body having the Bluetooth mounted thereto. In this function, when a call is received, the user recognizing the bell sound or vibration of the main body moves the switch of the Bluetooth from a locked position to an unlocked position, thereby performing the connection with the main body having the Bluetooth mounted thereto. After the connection, when data indicating call-receiving is received by the Bluetooth headset HS4, an answering data (ANSWER) is additionally transmitted to the main body (by pressing an MFB button), thereby performing the automatic call receiving function. Such a function has an advantage in that when a call is received, the user can immediately receive the call by simply moving the function button 12 up.

Of course, the operation of the power saving switch SP2 according to the signal of from ‘LOW’ to ‘HIGH’ in the above description may be inversely configured according to the intention of the designer.

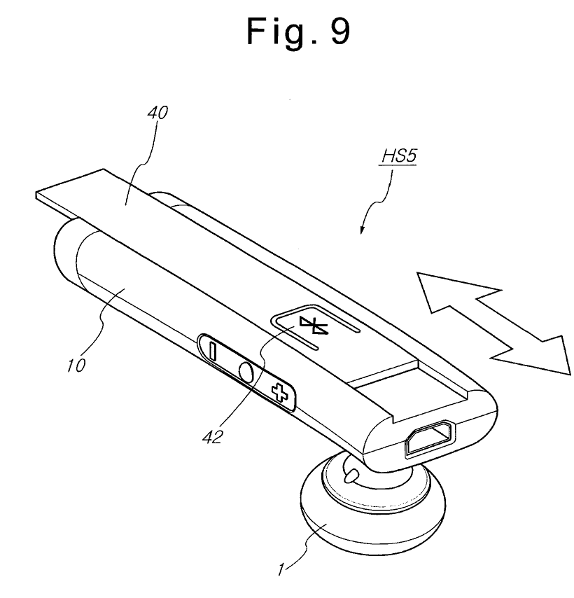

FIG. 9 shows a Bluetooth headset HS5 according to a fifth embodiment, in which the function button 12 according to the fourth embodiment as shown FIGS. 7 and 8 is combined to the slide type cover plate according to the second embodiment. Herein, the operation of HS5 is the same as those of other embodiments.

What is claimed is:

1. A Bluetooth headset comprising:
a headset body, which is a casing having an earphone part;
a function button embedded in a rear or lateral side of the headset body, which is used to operate a function of the Bluetooth headset, wherein in a storage space of the headset body, a circuit board is placed, the circuit board being designed for mounting an operating switch (such as an electric button switch) that operates by cooperation with the function button; and
a position changing means for changing a position of the function button with respect to the operating switch according to an operation of the function button by a user, wherein the function button and the operating switch are aligned with or misaligned from each other by the position changing means, so that a pressing of the function button provides an operable unlocked state or a non-operable locked state where operation or non-operation of the operating switch is selectively carried out.

2. The Bluetooth headset as claimed in claim 1, wherein the position changing means for changing the position of the function button with respect to the operating switch, and thereby allowing the operating switch to be selectively operated or non-operated by a pressing operation of the function button is within a predetermined distance provided to the headset body of the Bluetooth headset, wherein when the function button (which is slidable) and the operating switch (that is, the button switch) on the circuit board are in an in-line position or non-in-line position according to sliding movement of the function button, the operation or non-operation of the button switch is selectively carried out by the pressing operation of the function button.

3. The Bluetooth headset as claimed in claim 1, wherein the function button comprises:
a plate-shaped cover plate slidably put in a channel guide (that is, a guide channel) which extends upward/downward and is grooved into the headset body; and
a ‘U’-shaped cut elastic press part provided on the cover plate, which is designed to perform a pressing operation by interworking with the button switch of the circuit board.

4. A Bluetooth headset comprising:
a headset body, which is a casing having an earphone part;
a function button embedded in a rear or lateral side of the headset body, which is used to operate a function of the Bluetooth headset, wherein in a storage space of the headset body, a circuit board is placed, the circuit board being designed for mounting an operating switch (such as an electric button switch) that operates by cooperation with the function button; and
a position changing means for changing a position of the function button with respect to the operating switch according to an operation of the function button by a user, wherein the function button and the operating switch are aligned with or misaligned from each other by the position changing means, so that a pressing of the function button provides an operable unlocked state or a non-operable locked state where operation or non-operation of the operating switch is selectively carried out,
wherein, in addition to a selecting function of the non-operable locked state or operable unlocked state, a power saving means for converting power of the Bluetooth headset into an OFF mode or a sleep mode is further provided.

5. The Bluetooth headset as claimed in claim 4, wherein the power saving means comprises a magnet placed in the function button which slidably moves, and a hall switch on the circuit board,
wherein a micom senses a ‘LOW’ signal or a ‘HIGH’ signal by sensing separation or adjacency between the magnet and the hall switch, thereby performing a power saving function through conversion of the power of the Bluetooth headset into the OFF mode or the sleep mode.

6. The Bluetooth headset as claimed in claim 4, wherein the power saving means comprises a combination of a slide switch and another function button, aside from the function button and the operating switch,
wherein a micom senses a ‘LOW’ signal or a ‘HIGH’ by an ON/OFF signal of the slide switch cooperating with the operating switch according to sliding movement of the function button, thereby performing a power saving function through conversion of the power of the Bluetooth headset into the OFF mode or the sleep mode.

7. The Bluetooth headset as claimed in claim 4, wherein the function button comprises:
a plate-shaped cover plate slidably put in a channel guide (that is, a guide channel) which extends upward/downward and is grooved into the headset body; and
a ‘U’-shaped cut elastic press part provided on the cover plate, which is designed to perform a pressing operation by interworking with the button switch of the circuit board.

8. The Bluetooth headset as claimed in claim 4, further comprising logic for connecting a call, wherein when the call is received during conversion from a power saving mode by operation of a power saving switch into a normal operation mode, the call is connected after connection of the Bluetooth headset with a main body.
